(19) United States
(12) Patent Application Publication
(10) Pub. No.: US 2003/0220815 A1
(43) Pub. Date: Nov. 27, 2003

(54) System and method of automatically determining and displaying tasks to healthcare providers in a care-giving setting

(76) Inventors: Cathy Chang, Johnson Creek, WI (US); Carl D. Dvorak, Madison, WI (US); Khiang Seow, Madison, WI (US); Brian Stoll, Madison, WI (US); Bill Vanderson, Madison, WI (US); Daniel Wang, Madison, WI (US); Brent Warner, Madison, WI (US)

Correspondence Address: MARSHALL, GERSTEIN & BORUN, 233 S. Wacker Drive, Suite 6300, Sears Tower, Chicago, IL, 60606-6357, US

(21) Appl. No.: 10/396,636

(22) Filed: Mar. 25, 2003

Related U.S. Application Data
(60) Provisional application No. 60/367,588, filed on Mar. 25, 2002.

(51) Int. Cl. G06F 17/60

(52) U.S. Cl. 705/2

(57) ABSTRACT

A method of determining and displaying a plurality of tasks to a user in a healthcare environment is provide that includes receiving an order associated with a patient, determining a type of the order, and identifying a task template associated with the order. The method further includes determining if an overriding template exists for the order, linking one of the task template or the overriding template to the order, and associating one or more task records with the linked template. The method also includes determining a plurality of tasks corresponding to the task records, adding the plurality of tasks to a work list, filtering the plurality of tasks on the work list for a patient list based on an attribute of the user and displaying the filtered list to the user.

### CROSS-REFERENCE TO RELATED APPLICATIONS

This application claims priority to U.S. Provisional Application Serial No. 60/367,554, entitled “System and Method of Automatically Determining and Displaying Tasks to Healthcare Providers in a Care-Giving Setting,” filed Mar. 25, 2002 (attorney docket no. 29794/38217), the disclosure of which is hereby expressly incorporated herein by reference.

### TECHNICAL FIELD

This patent relates generally to computer software that generates lists of tasks, and more particularly, the invention relates to filtering and managing caregiver tasks in an electronic medical record (EMR).

### BACKGROUND

In a healthcare setting, one order placed by a physician can comprise multiple care tasks for the patient. These tasks are then undertaken by various caregivers, with each caregiver responsible for tasks based on legal requirements, hospital policy, and training expertise.

With multiple people responsible for the various tasks for each patient, coordinating care can prove to be a complex effort. Different caregivers need different information on what tasks need to be performed for the patient, and locating the essential factors in a single list of tasks can be difficult. For example, on a list of tasks, a doctor may be looking for the tasks he or she must do to care for a particular patient, while a nurse or other caregiver may need information in a more time-based format, so that he or she knows that at a certain time a task must be completed. When information cannot be sorted by factors such as the patient or time frame, and exists only as a static list, key information can be overlooked.

In addition, with all of the activity taking place in a healthcare setting on a daily basis, it is difficult to keep track of how long a task may take a caregiver, and how each individual task fits into the larger schedule. Therefore, there is not an efficient way to estimate needs for staffing based on the number of tasks that are done and the time that it takes to complete each one. Without this information, a healthcare facility may have difficulty keeping up with the monitoring of staffing needs, resulting in not enough caregivers to give adequate patient care. Similarly, without a tracking method, it is difficult to measure staff productivity and compare how much work a caregiver can accomplish compared to his or her peers, making it harder to determine which caregivers are the most effective.

Every caregiver needs to be able to determine which of the tasks scheduled for the patient they are able to perform based on their knowledge and legal requirements, but these requirements may not always be well defined. If caregivers can view a list of tasks for only one patient, not only do they have to determine which of the tasks they are capable of performing, but they also must keep the bigger picture of the healthcare setting in mind—otherwise, there is the possibility of tasks for other patients being forgotten, or with one person having such a great number of tasks that they can't all be completed within the time specified. Additionally, caregivers with the same knowledge and legal requirements need to be able to cover for other caregivers when they are busy or unable to perform their tasks—information must be passed along so that the covering caregivers know which tasks they can perform, and if the task has already been performed by someone else. If the caregivers are not able to coordinate their work, there is a risk that tasks will not be completed in an appropriate time frame. When tasks are not performed according to schedule, the consequences are severe—up to and including the death of patients.

For many years, attempts have been made to solve these problems using manual efforts that involve paper systems or greaseboards. In some paper systems, caregivers keep track of the tasks they need to accomplish by writing a series of notes to themselves and then checking off the tasks when they are completed. These notes are easily misplaced or thrown out, leaving no permanent record of what tasks were accomplished and who completed them, or what tasks were not performed at all. Similarly, through the use of a paper Kardex report, caregivers can keep track of all of the orders that have been placed for a patient and note when they are completed. However, this report is not considered part of the patient's permanent record, and documentation of these tasks must be kept elsewhere as well. Therefore, in order to keep themselves organized, caregivers must document their duties and the completion of them in more than one location.

Similarly, the greaseboard system does not result in a permanent record, or give any guidance as to who should perform given tasks. In these systems, a list of patients and the tasks that need to be done for their care are listed on an erasable board. Like paper systems, greaseboard schedules do not automatically respond to the needs of a particular order. In addition, although everyone can view them, it is not well defined who can perform specific tasks listed. Since the greaseboard information can only be found in one place, all caregivers must physically move to that one location to collect information on tasks that must be done. In addition, due to laws protecting the privacy of patients, the greaseboards may not have complete information about the patients and their needs. There is also a greater risk for error in such systems as someone might write down a task for the wrong patient, or information on the board may be accidentally erased.

Other solutions involve software to manage patient care. In these systems, like the greaseboard system, all tasks are shown, leaving the caregivers to sort out which ones they are able to perform. Making caregivers look through all of the information to determine what they need to perform is inefficient as it takes time away from their actual duties with the patient. In addition, if the list only shows tasks that need to be done for one patient at a time, caregivers do not gain a comprehensive view of all of the work that needs to be done and take that into consideration when managing their time.

### BRIEF DESCRIPTION OF THE DRAWINGS

This patent is illustrated by way of example and not limitation in the accompanying figures, in which like references indicate similar elements, and in which:

FIG. 1 illustrates in block diagram an overview of an embodiment of an activity assignment engine.

FIGS. 2A and 2B illustrate exemplary user interfaces for a Task Template record.

FIG. 3 illustrates an embodiment of a user interface for entering information into a Task Record.

FIG. 4 is a flowchart illustrating some of the steps that are used in finding an appropriate Task Template.

FIG. 5 is a flowchart representation of some of the steps used to schedule tasks for a Work List.

FIG. 6 illustrates in flowchart form some of the steps through which Patient Lists may be built.

FIG. 7 is a flowchart representation of some of the steps by which a Work List is built from a Patient List.

FIG. 8 illustrates an exemplary user interface of a Work List having a patient centered grid view.

FIG. 9 is a representation of one possible embodiment of the Work List interface with a Time Centered View.

FIGS. 10-12 illustrate three exemplary flowcharts describing methods of filtering tasks.

FIG. 13 is an exemplary flowchart illustrating how a user can add tasks from an integrated user interface.

FIG. 14 is a flowchart illustration of some of the steps used to enable a user to edit tasks previously scheduled from a user interface.

FIG. 15 is a flowchart illustrating some of the steps used to convert a task into a Sign Out Note.

FIG. 16 illustrates an exemplary flowchart for some of the steps used for task escalation purposes.

FIG. 17 illustrates the use of work units in a Work List.

### DETAILED DESCRIPTION OF THE DRAWINGS

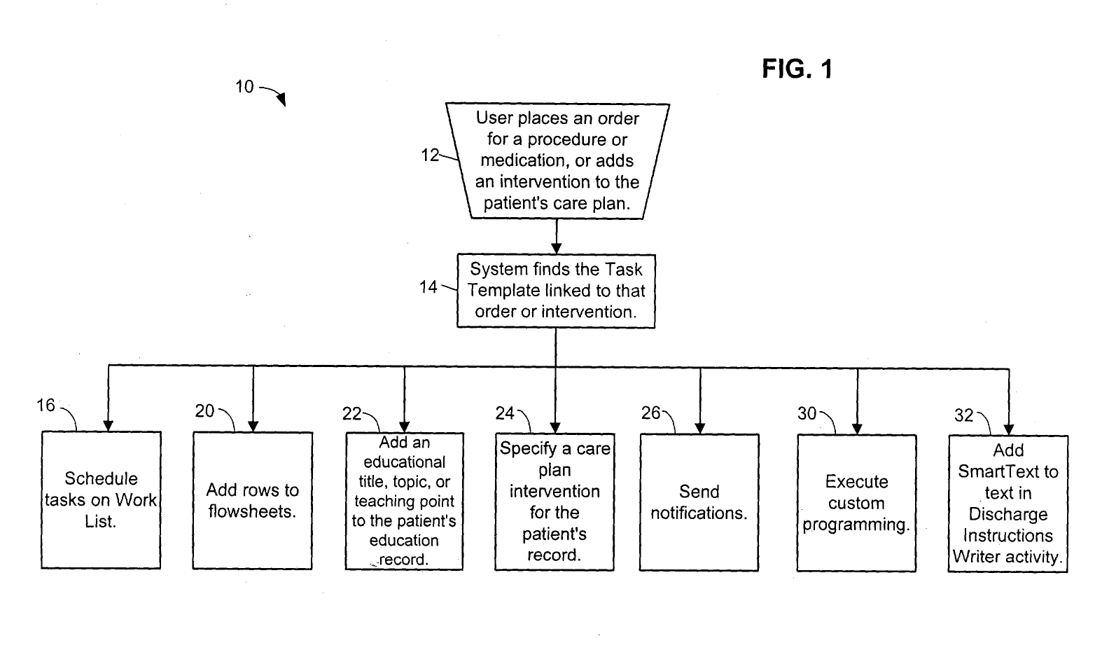

FIG. 1 illustrates an overview of an embodiment of an activity assignment engine 10 constructed in accordance with the teachings of the invention. As a general overview, the activity assignment engine 10 may be part of an integrated suite of software used for the administration and management of healthcare. The activity assignment engine 10 determines the times that tasks (i.e. projects, activities, responsibilities, etc.) are to be performed as well as assigning those tasks. As described in greater detail below, the activity assignment engine 10 may dynamically filter a plurality of generated tasks for a list of patients. The activity assignment engine 10 may further provide support for managing the tasks on a worklist by implementing task escalation, analyzing task time requirements, and using recorded tasks to document patient care issues.

The activity assignment engine 10 includes a computerized system for viewing the tasks that are needed to care for meaningful subsets of patients at the same time as well as providing the capability to filter the tasks based on the person viewing the list, using criteria such as the user's discipline, licensure, and skill set. These terms are described in detail below. One or more tasks may be added to a task list through a user interface in addition to those tasks automatically scheduled. Furthermore, both automatically scheduled and user-added tasks can be edited through the user interface.

The activity assignment engine 10 can implement an escalation of tasks if a task is not performed as scheduled, keep track of what tasks need to be done, and measure staffing needs through the use of work units for each task. The activity assignment engine 10 may further provide the capability to convert tasks on a Work List into notes to document patient care issues.

Still referring to FIG. 1, the activity assignment engine 10 illustrates the process of an Activity Assignment Engine in producing one or more tasks. In general, the Activity Assignment Engine requests medications in accordance with MAR, manages standing orders, and schedules tasks on Work Lists. In this context, the term “MAR” shall refer to the ability of a caregiver to view and document many aspects of a patient's receipt of a medication, including, for example: when a patient is scheduled to receive a medication; how the medication was administered; where the medication was administered; and whether any interactions exist.

As shown in a block 12, a user may place an order for a procedure, a medication, or an intervention to a patient's care plan. Once an order is placed or a care plan intervention is added, the activity assignment engine 10 looks for a Task Template linked to that order or intervention at a block 14. In this context, the term “Task Template” shall refer to a template that holds information that is used to automatically react to an order or the addition of a care plan intervention with the appropriate responses. Also, in this context, the term “care plan intervention” is intended to refer to a step that is added to a patient's plan of care to work toward eliminating one of the patient's problems.

The Task Templates specify the actions that should be taken for each given order or intervention. These actions include scheduling tasks on a worklist as shown at a block 16 and adding rows to a particular flowsheet at a block 20. Other actions include adding an educational title, topic or teaching point to a patient's education record at a block 22, adding interventions to the patient's care plan at a block 24, and launching any notifications programming points at a block 26.

Additional actions may also include executing any additional actions using custom programming at a block 30 as well as adding designated text (SmartText) to a patient's discharge instructions (block 32). A software product directed to the application of SmartText is commercially available from Epic Systems Corporation of Madison, Wis. In this context, the term “SmartText” shall refer to a template or block of text created by a caregiver or the healthcare facility that can be used in a variety of locations throughout the software suite (depending on the defined text type).

In addition to specifications on how the interface should react to the orders, the Task Template may also contain a record for each component that makes up the order. Multiple Task Records can be associated with a Task Template, covering all of the elements of the order that must be completed. In this context, the term “Task Record” refers to specific information collected to generate a task.

The information found in the Task Templates and the Task Records associated with the templates may be used by the activity assignment engine 10 to automatically react to each order or intervention with appropriate responses. Some responses may alter the interface based on the order or intervention (described above), while others add tasks (components of the original order) to the system.

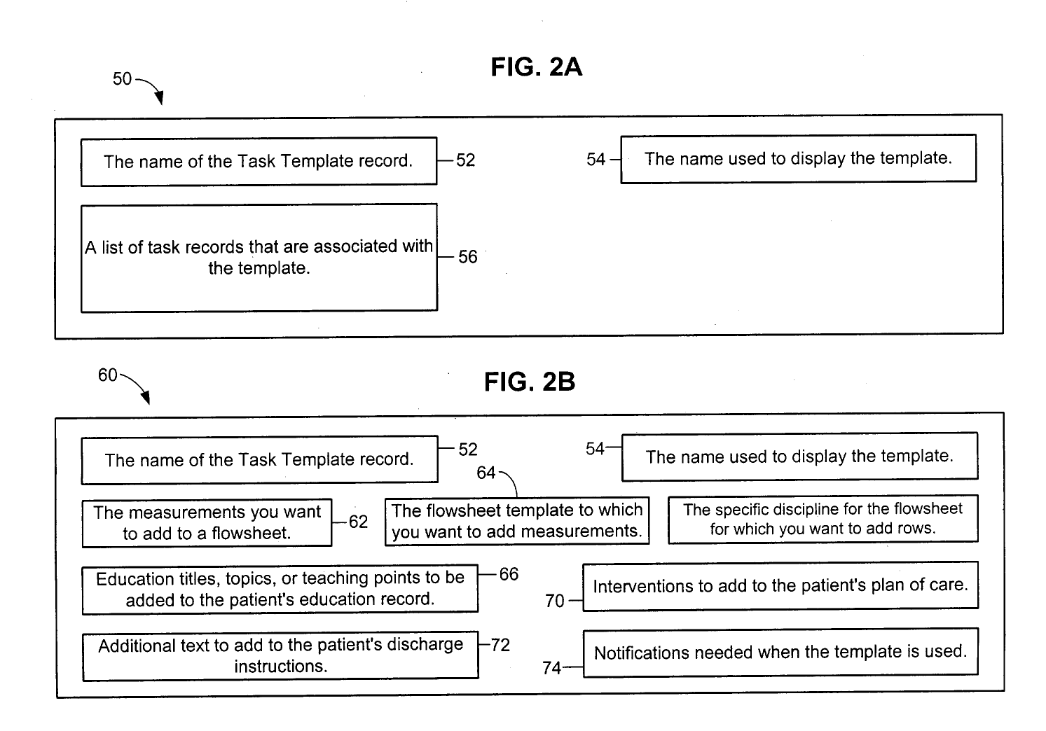

FIGS. 2A and 2B illustrates embodiments of a first and a second user interface for a Task Template record into which a user may enter information using a plurality of data entry fields. It should be noted that only users with the proper security clearance can access the template records.

In FIG. 2A, the user interface 50 of the Task Template record allows the user to enter in both a name for the template (which can be used to look up the template again for modifications) at an entry field 52 and the display name of the template at an entry field 54. It is through this user interface 50, in an entry field 56, that the user can specify the Task Records that should be associated with this task. Each Task Record is entered on an individual line, and the user can press F6, or any other key configured as a shortcut, to move from the template record to the Task Record and view the information the Task Record contains.

In FIG. 2B, the exemplary embodiment of the user interface 60 of the Task Template record allows the user to specify the actions that will be taken once the template is identified for an order or for the addition of a care plan intervention. On this user interface 60, the user can specify the measurements that should be added to a particular flowsheet at an entry field 62 and measurements that should be added to a specific discipline's flowsheet at an entry field 64. The user can also fill in specific titles, topics, or teaching points that should be added to the patient's education record at an entry field 66, and any interventions to be added to the patient's plan of care at: an entry field 70. Titles, topics, and points refer to educational materials that can be added to patients' education records in order to help them to learn about their illnesses or the medications that they are taking. In addition, text can be designated on this screen at an entry field 72 to add to the patient's discharge instructions, or a notification can be set up at an entry field 74 to launch when the template is accessed.

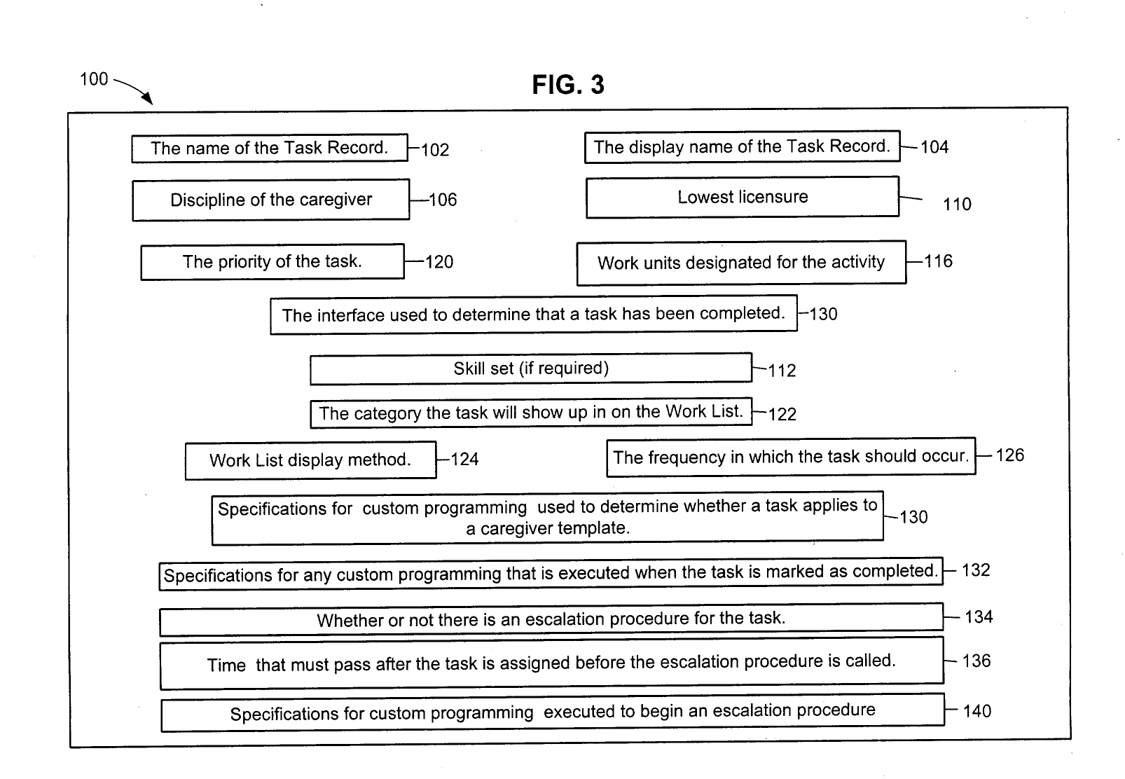

FIG. 3 illustrates an embodiment of a user interface 100 for entering information into a Task Record. As with the Task Template record, only users with the proper security clearance can access the Task Record.

In the Task Record's user interface 100, the user can specify the name and display name of the task at entry fields 102 and 104 respectively. The user can also specify the information that will be used to determine who can perform the task (and thus is used in task filtering), including the discipline of the caregiver that can perform the task at an entry field 106. In this context, the term “discipline” refers to the area in which the caregiver has been trained, such as nursing, physical therapy, or respiration therapy. The actual person doing the activity would depend on the licensures in that discipline. The term “licensure” in this context shall refer to the level of certification that the user has achieved in the medical field, such as, for example, R.N., M.D., or L.P.N. The user may specifiy the lowest caregiver licensure that can fulfill the duty at an entry field 110. The user may also specify any required skill sets that the caregiver must have at an entry field 112, wherein the term “skill sets” is intended to refer to the expertise of the care giver, such as chemotherapy administrator, central line draw, etc.

As an example, if an RN must perform an IV push, then the discipline might be Nursing and the minimum licensure would be RN. The Task record also has an entry field where custom programming can be specified that can be used to determine whether a task applies to a caregiver, using criteria other than that supplied through the template.

Users entering information into the Task Record at an entry field 116 are able to specify how many work units that the task will take, which can be used to judge staffing needs and employee productivity. The work units designated for the activity may be a numeric value used to represent the work that will be done when the activity is complete.

Other options in the Task Record may determine how the task will be scheduled. The user can enter in information about the priority of the task (low to high) at an entry field 120 and the category in which the task will display at an entry field 122 (for example, a Digoxin order could be set up to display in a Medications category). The Task record also can contain information on how the Work List displays when a task should be performed—either using the frequency at which the task should be performed as a number of times per day, followed by the number of times the task has been performed on that day, or by a set time to complete the task. The method of displaying the Work List can be entered at an entry field 124. Any frequency instructions included with the original order can be overridden at an entry field 126.

The Task Record may also specify information on completing tasks. In an entry field 130, the user can designate what interface is used to document that the task has been completed—whether it is by noting new values in a flowsheet or adding a note to the patient's record. When the user clicks on the task in the Work List, he/she may be brought to the necessary activity tab to complete the assigned task. If the entry field 130 is left blank, clicking on the activity in the Work List will simply check it off as done.

Custom programming can be specified at an entry field 132 to take actions once the completion of the task has occurred. A number of entry fields deal with the escalation of tasks, where the user can specify if escalation should take place if the task is not completed during a certain time frame (defined in the Task Record as well). The entry fields associated with escalation are entry fields 134 and 136. An entry field 140 may also be used to specify what form a task escalation should take (i.e. an escalation procedure for the task if it is overdue).

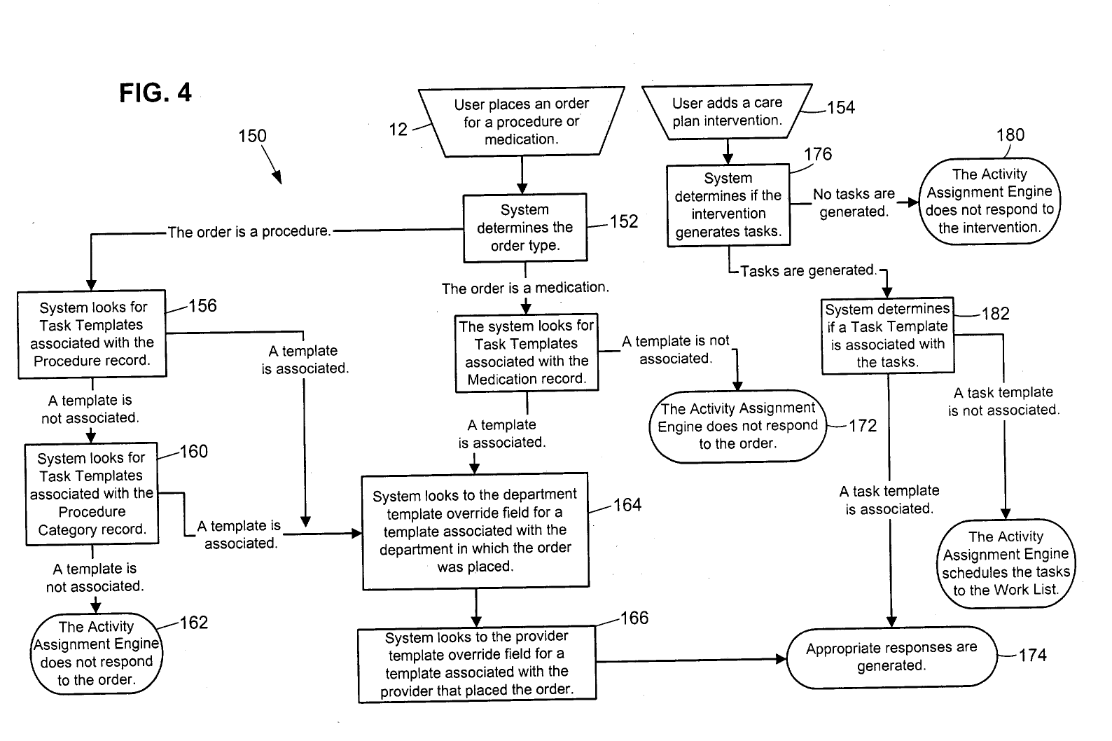

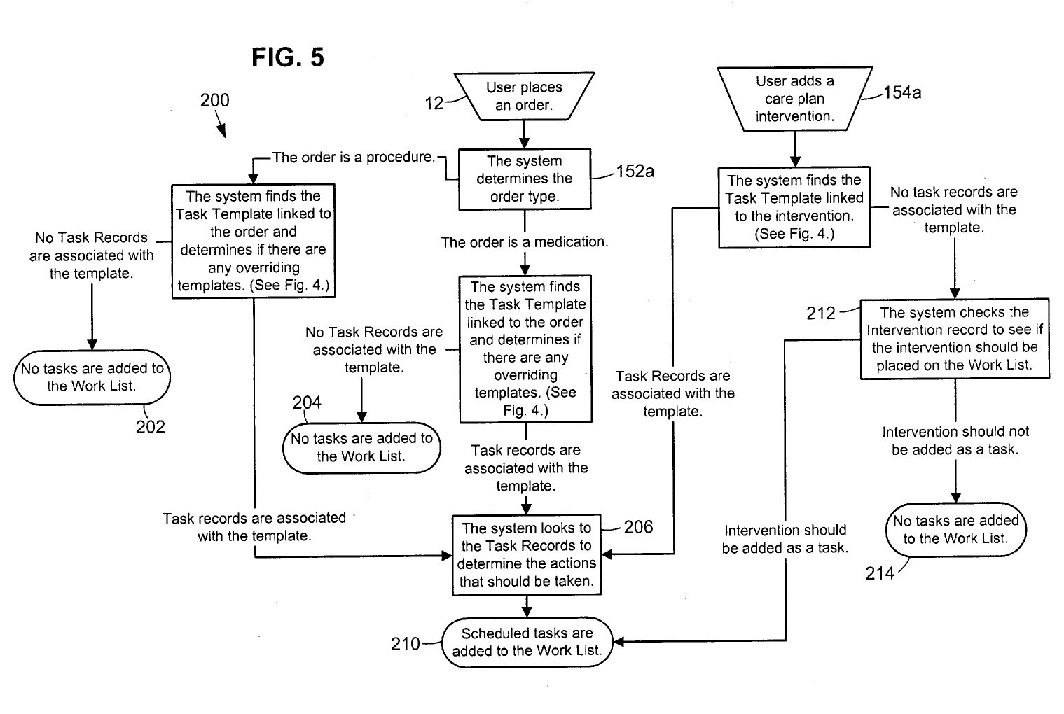

FIG. 4 illustrates a flowchart 150 of some of the steps that occur after an order is placed or a care plan intervention is added to find the Task Template (recorded in the corresponding Medication, Procedure, Procedure Category, or Intervention Type master file) and handle any overriding template settings.

The first thing that is determined to find the Task Template for an order is the type of order that has been placed (block 152)—whether it is a procedure (including laboratory tests and imaging orders) or medication order. If an order has not been placed, but a care plan intervention has been added (block 154), a Task Template may be located through a slightly different process.

If an order has been placed for a procedure, a next step in finding the appropriate Task Template is to look to the Procedure record (block 156). If no templates are associated with this record, the activity assignment engine 10 looks to a Procedure Category record (block 160). If there are also no templates associated with that record, the activity assignment engine 10 does not respond to the order (block 162). However, if a template is associated with either the Procedure or Procedure Category record for the order placed, a next step in the process—a search for an overriding template—may begin. In the Procedure or Procedure Category record, an overriding template can be specified at the department (block 164) or the provider level (block 166). The Procedure or Procedure Category record can list multiple departments and templates that should be associated with each; if the department in which the order was placed appears in the list, the template listed with that department may override the template that is associated with the Procedure or Procedure category record (block 169). If the provider that placed the order is listed in the Procedure or Procedure category record with yet a different template, that template may override any template at the department level or at the Procedure or Procedure category record level (block 166).

For example, if a doctor in the West Family Practice department places an order for a complete manual hemogram (CBC), to locate a Task Template, the system may first look to the Procedure record for the CBC. If a template is specified in that record, the system may then look to see if that record has any template overrides at the department level. If there is an overriding Task Template for the West Family Practice department specified, the Task Template at the Procedure level may not be used. Then, if in the Procedure record there is an overriding template for the particular provider that placed the order, the template associated with the provider may be used instead of that of the procedure or department. If there is not a Task Template associated with that provider, the one specified at the department level (for West Family Practice) may be used. If an overriding template is not specified at the department or provider level, the template at the Procedure level may be used.

If a template is not specified at the level of the procedure (CBC), the system may look for a Task Template that is associated with the Procedure Category for that procedure, Laboratory/Pathology. If a template is associated with the Procedure Category, the same checks in that record for department and provider overrides may be made. If a template is not associated with the Procedure Category, an Activity Assignment Engine may not respond to the order.

Medication orders are dealt with similarly. If an order has been placed for a medication, the system may first look in the Medication record for the Task Template (block 170). If a template is not associated here, the invention may not respond to the order (block 172). If a template is associated, the system may look to the department and ordering provider settings found in the Medication record, as detailed above (blocks 164 and 166). Then the appropriate responses to the order may be generated (block 174).

If a care plan intervention has been added (block 154), the activity assignment engine 10 determines whether the intervention generates tasks (block 176). If no tasks are generated with the intervention, the activity assignment engine 10 may not respond to the intervention (block 180). If tasks are generated with the intervention, the system may determine if a Task Template is associated with the Intervention record (block 182). If a template is not associated, the Activity Assignment Engine schedules a task to the Work List with the frequency of the intervention (block 184). If a template is associated, no further override checks are made, and the appropriate responses are generated (block 174).

FIG. 5 is a flowchart 200 illustrating some of the steps used to schedule-tasks for a Work List through the activity assignment engine 10. After an order is identified as a procedure or medication order (block 152a), or a care plan intervention has been added (block 154a), the system may find the Task Template linked to the order (see FIG. 4).

Prior to the user placing an order or adding a care plan intervention; information regarding the tasks may be set up ahead of time. This is done through the creation of Task Records (see FIG. 3) and Task Templates (see FIG. 2). The Task Template specifies the Task Records that should be used to create scheduled tasks. The template to be used is then specified in the record for the order or care plan intervention.

For example, assume that when a physician places an order for Digoxin, two tasks should be scheduled on the Work List. Every six hours, a nurse should administer a dose of Digoxin. Since there is a small margin of error in administering Digoxin, a nurse should monitor the patient's heart rate each hour. To accomplish this, two Task Records are created, one for administering the Digoxin and one for checking the patient's pulse rate. These Task Records are recorded on a Task Template, along with any other actions the Activity Assignment Engine should take in response to the order. Finally, the Task Template is recorded in the medication record for Digoxin.

For procedure and medication orders, if no Task Records are associated with the Task Template, no tasks are added to the list (blocks 202 and 204). If Task Records are associated with the template, the activity assignment engine 10 may refer to these records (block 206) and use the information in them to create scheduled tasks for the Work List (block 210).

Care plan interventions operate similarly. If Task Records are associated with the Task Template, the activity assignment engine 10 may use the Task Record information (block 206) to create scheduled tasks on the Work List (block 210). If Task Records are not associated with the template, the system may check the intervention record to see if the intervention has been designated as a task to be placed on the work list (block 212). If the intervention has been constructed as such, it may be added to the Work List as a task (block 210). If the intervention has not been identified as a task, no tasks are added to the list (block 214).

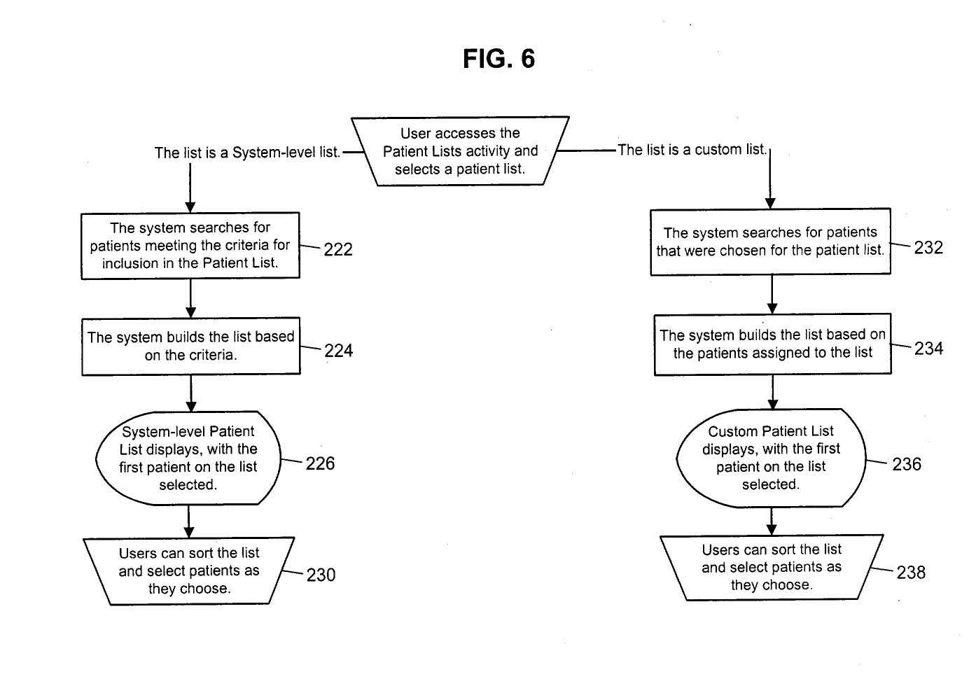

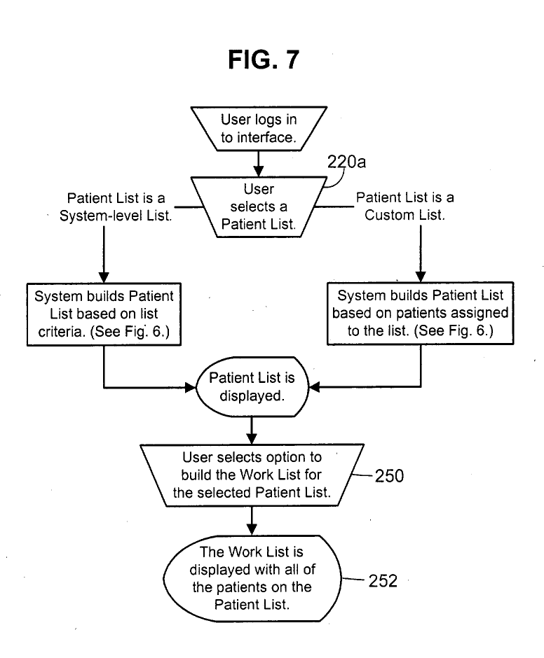

FIG. 6 illustrates in flowchart form some of the steps through which a Patient List (a listing of patients) may be built. Each Work List is based on a Patient List, and has the same set of patients as the Patient List.

When the user logs into the system and accesses the Patient Lists activity, a number of Patient Lists are available. When a list is selected (block 220), the system determines the list's type. Two examples of Patient List types are:

System-level Patient Lists that are defined by certain criteria, and include patients who fit the list's criteria. The list may be automatically updated, adding and removing patients as necessary. An example of a System-level Patient List includes a floor or service census, containing patients roomed or treated in a particular location, such as rooms covered by a nurses' station. Another example of a System-level Patient List is a list of patients based on their relationships to a provider, such as all of the patients for whom the provider is the attending physician, consulting physician, or primary care provider (PCP).

Custom Patient List may be built by users and include patients selected by the users of the list.

If the list is a System-level Patient List, the system may search for patients meeting the criteria for inclusion in the Patient List (block 222). Criteria that may be used to determine whether or not to incorporate a patient on the list can include the patient's location within the healthcare facility, as well as information from the patient's electronic medical record, such as the patient's admission type, diagnosis, or diet preferences (block 224). For example, if a System List was created to search in the West Family Practice Department using the criteria of the patient's name and a diagnosis of abnormal heart sounds, only those patients that fit that criteria will display in the patient list—other patients in that department with different diagnoses will not display. The patients may then be displayed, sorted by the information found in the column that has been specified as the first column in the list (block 226). When the list displays, the patient at the top of the list may be selected, and his or her information can be viewed in a report format (specified in the Patient List setup) on the screen. The user can then sort the list as necessary, clicking on a column in the list to sort by that particular information (block 230).

Custom patient lists may be created based on a specific set of patients. If the list selected is a Custom List, the system may search for the patients that have been specified for that list (block 232). Then, the system may build the list based on those patients (block 234). Like the System-level list, when the list displays, it may be sorted by the information found in the column that has been specified as the first column on the list, and the patient at the top of the list may be selected and shown in the report (block 236). The user may be given the option to sort the list as necessary by clicking on a particular column (block 238).

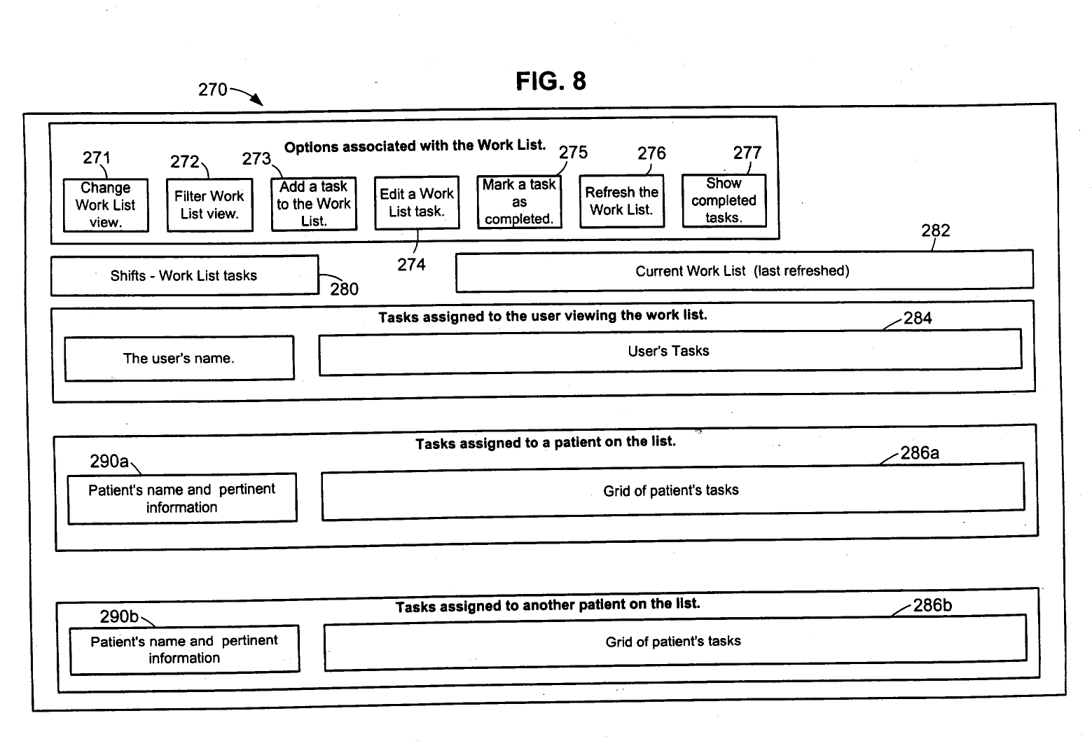

FIG. 7 is a flowchart representation of some of the steps by which a Work List is built from a Patient List. (See FIG. 6.) When a Patient List is built and displayed, the user has the option of building a Work List based on that list (block 250). When the user selects the option to build a Work List, the Work List collects the tasks that have been assigned for those patients on the list, and displays them in the default Work List view specified in the user's settings (block 252). Patients may be displayed in the Work List in the order in which they are sorted on the Patient List from which it was built, and patients for which caregivers do not have any tasks may still show up in the Work List, since every patient on the Patient List is represented. If the user's settings have the Patient Centered Grid View as the default (see FIG. 8), the information that displays along with the tasks is customizable by the healthcare facility. For the other Work List views, the information that displays with the tasks may be standardized for each view.

In either case, however, information is pulled from the patient's electronic medical record, such as the patient's name, bed assignment, age, diagnosis, and allergies. This information is then available at a glance to the user viewing the Work List, and more information can be accessed from the patient's record.

FIG. 8 illustrates an exemplary Work List interface (block 270), wherein the Work List has a patient centered grid view. This patient centered grid view shows the Work List based on the user and the patients on the Patient List.

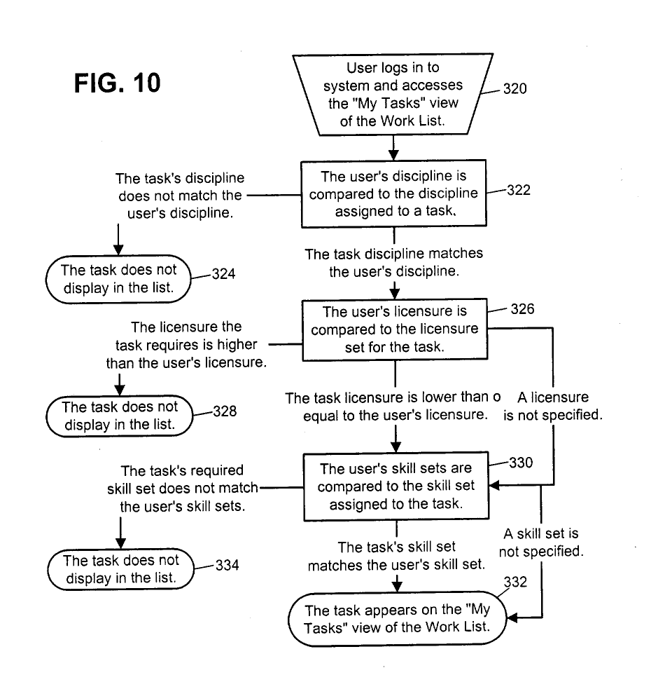

The top of the diagram shows a variety of possible options 271-277 associated with the Work List. The option 271 allows a user to change the selected view from the patient centered grid view to a patient centered category view or a time centered view. Additional options may include filtering the Work List 272 in three different ways (see FIGS. 10-12); adding 273, editing 274, marking tasks as completed 275, refreshing the list for the most recent information 275, showing all completed tasks 277, etc.

Below these options is the Work List status information. The shifts into which the Work List tasks are divided is displayed in a field 280, as well as text specifying which Work List view is currently displayed and the time when the list was last refreshed in a field 282.

The user's tasks may be listed in a grid next to the user's name in a field 284. Each task may appear as a row in the grid. When the user clicks the first column of a row, the system may open the activity in the patient's chart used to document the completion of that activity. Each column may represent an hour during the selected shift. If an entry appears in a cell, it means that a task needs to be done during that hour. Tasks that need to be done at any point during the shift may have an entry in the Shift cell.

Below the user's tasks are tasks divided out by each patient on the selected Patient List. Each patient's name may appear next to a grid of tasks (fields 286a and 286b), along with other pertinent information from the patient's electronic medical record, which could include the patient's bed assignment and allergies (field 290a and 290b). This information may be configurable. As with the user's information, each task may appear as a row in the grid. When the user clicks the first column of a row, the system can open the activity in the patient's chart used to document the completion of that activity. Each column may represent an hour during the selected shift. If an entry appears in a cell, it means that a task should be done during that hour. Tasks that should preferably be done at any point during the shift may have an entry in the Shift cell.

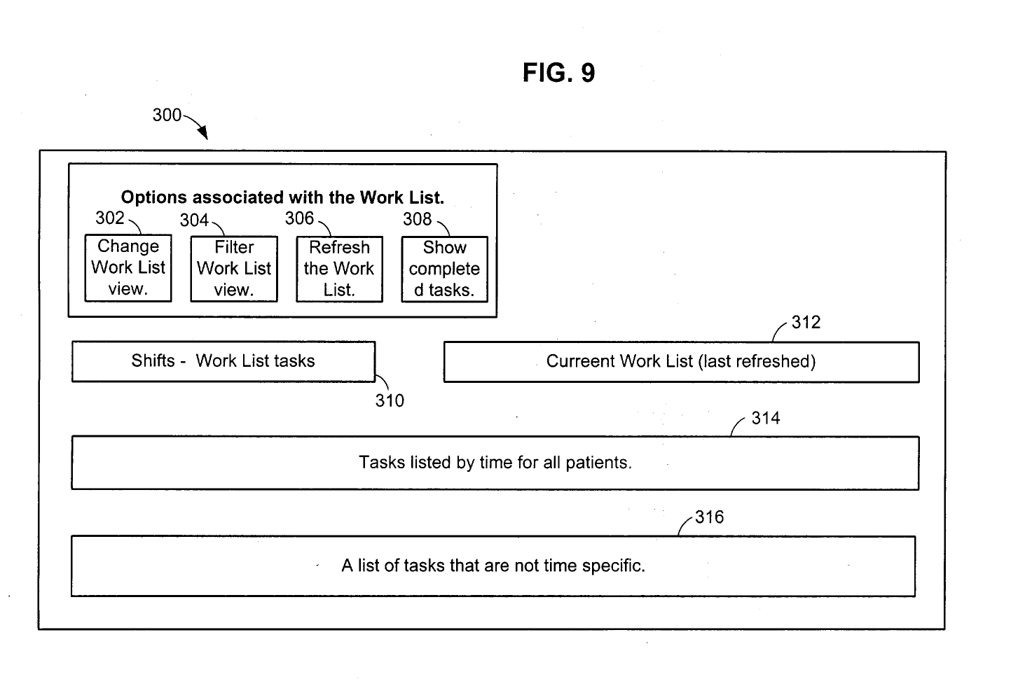

FIG. 9 is a representation of one possible embodiment of the Work List user interface 300 with a time centered view. This time centered view shows the Work List based on the times for which tasks are scheduled through the activity assignment engine 10 or from directly entering a task with a time and frequency onto the Work List.

The top of the user interface 300 shows a variety of options 302-308 that may be associated with the Work List. These options allow you to change the selected view from the time centered view to the patient centered category view or the patient centered grid view (option 302). Additional options include filtering the Work List in a plurality of different ways 304 (see FIGS. 10-12), refreshing the list for the most recent information 306, and showing all completed tasks 308.

Below these options is the Work List status information. The shifts into which the Work List tasks are divided is displayed in a field 310, as well as text specifying which Work List view is currently displayed and the time when the list was last refreshed in a field 312. The time-specific tasks may be displayed for all patients on the Patient List in a field 314. For each task, the user can see to which patient the task applies, the patient's bed, the name and priority of the task, any comments entered with the task, etc.

Below the tasks listed by specific times is a field 316 that includes a list of tasks that are not time specific. As with the time-specific tasks, the user can see to which patient the task applies, the patient's bed, the name and priority of the task, any comments entered with the task, etc.

FIGS. 10-12 illustrate three exemplary flowcharts—describing methods of filtering tasks. The person using the system can change the filter to control the tasks that are shown.

FIG. 10 illustrates the ability to filter tasks shown so that a user can see only his or her tasks. When the user accesses the Work List (block 320), the system may compare the user's discipline to the discipline assigned to the tasks on the list (block 322). If the disciplines do not match, those tasks may not be shown on the list. If the task disciplines do match the user's discipline, the system may proceed to check the user's licensure against the licensure that is associated with the task (block 326). If the task requires a licensure that is higher than the user's licensure, the task may not display in the list (block 328). If the task requires a licensure that is lower than or equal to the user's licensure, or if a licensure has not been specified in the task, the system proceeds to check the skill set information (block 330). If one of the user's skill sets matches the skill set required of the task, the task displays in the “My Tasks” view of the invention (block 332). If none of the user's skill sets matches the skill set specified for the task, the task does not display (block 334). If a skill set for the task is not specified, the task may display in the “My Tasks” view (block 332).

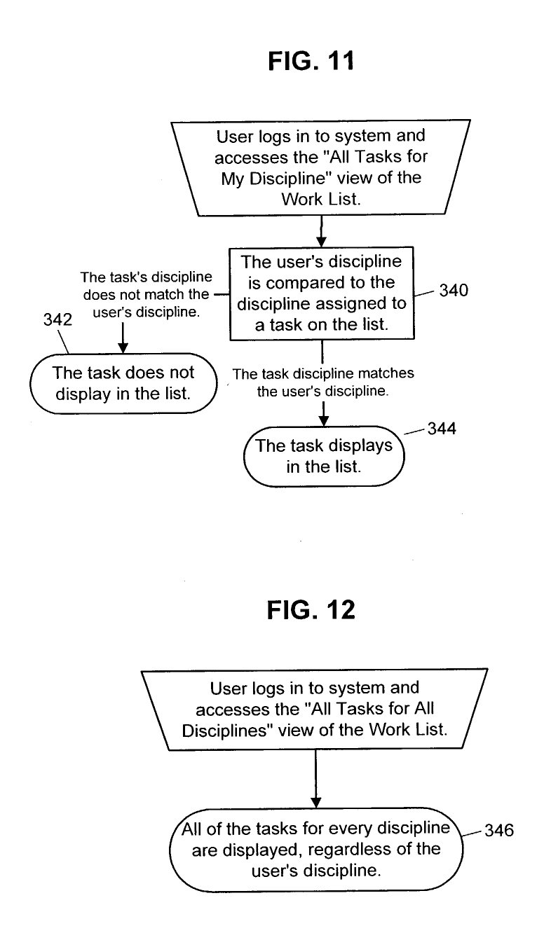

FIG. 11 illustrates the ability to filter tasks shown so that a user only sees tasks that match his or her discipline. When the user accesses the Work List, the system may compare the user's discipline to the discipline assigned to the tasks on the list (block 340). If the task's discipline does not match the user's discipline, the task does not display in the list (block 342). If the discipline of the user and the task match, the task displays in the list (block 344).

FIG. 12 illustrates the ability to filter tasks shown so that all tasks are shown for all disciplines. When the user accesses the Work List, the system allows all of the tasks for every discipline to display, regardless of the user's discipline (block 346).

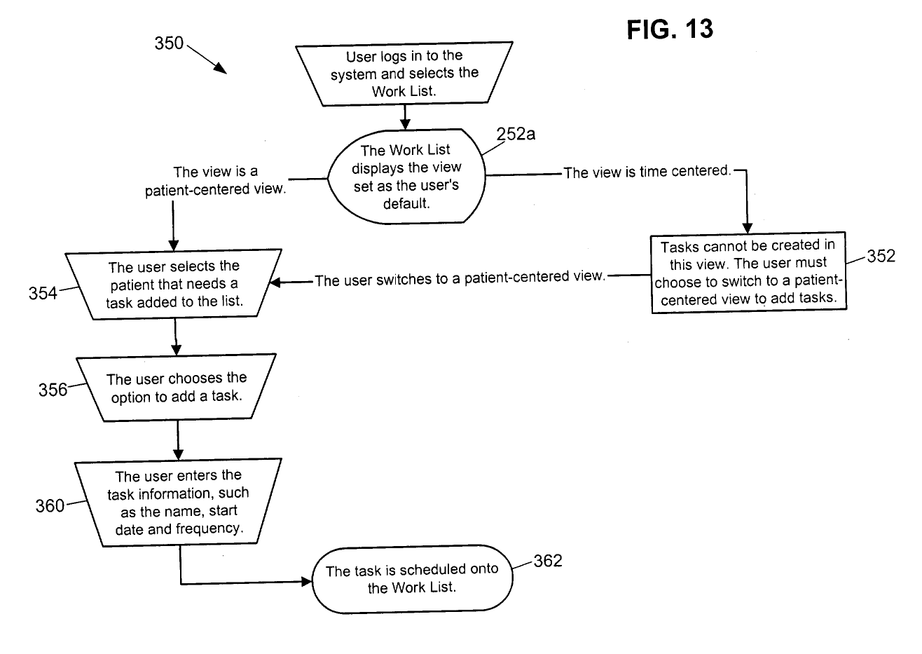

FIG. 13 is an exemplary flowchart 350 illustrating how a user can add tasks from an integrated user interface. Once the user logs in to the system and selects the Work List option, the Work List may be built from the selected Patient List (see FIG. 6). The Work List displays (block 252a) using the view that is set up in the user's default preferences (see FIG. 7). If the user's default view is time centered, the user may be restricted from adding new tasks to the Work List (block 352). If the user wants to add tasks, he or she could change the Work List view to a patient-centered view.

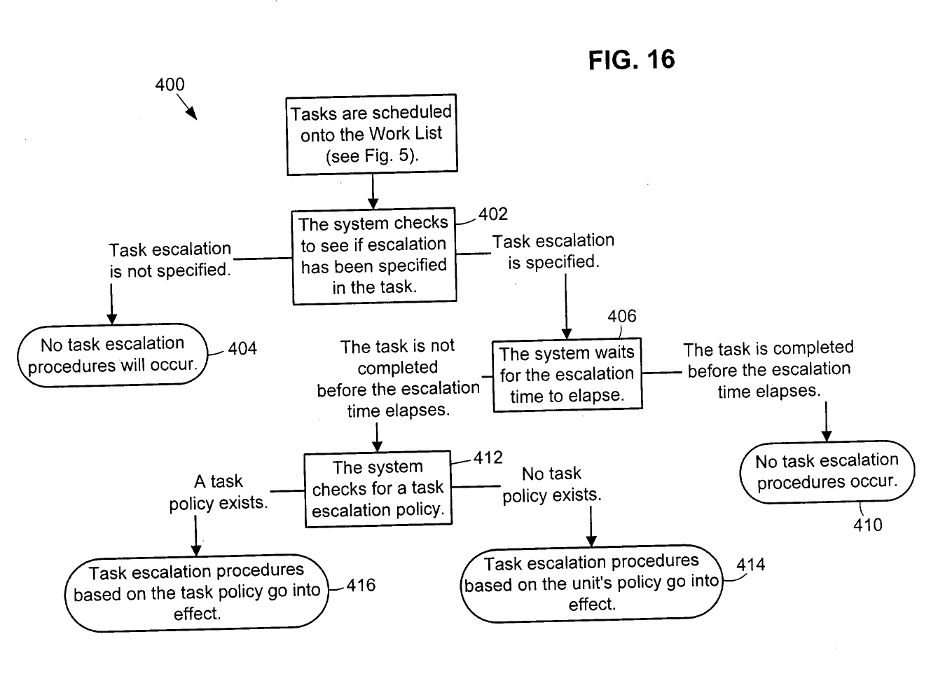

In a patient-centered view, the user can select the patient that needs a task added (block 354), and then choose the option to add a task (block 356). A window may be configured to appear to allow-the user to enter information about the new task, such as its scheduling (start date and time, frequency, end date) as well as details on which caregivers can perform the task, identifying disciplines, licensures, and skill sets required to complete the duty (block 360). Comments can be added for the task, as well as how the task can be marked completed, the category in which the task should be displayed, its priority, and the number of work units the task will take to accomplish. In this window, the user can also designate that the task should appear on the Sign Out Report (see FIG. 15). Once the user has entered the information needed for the new task, he or she can accept the task, and it is then scheduled onto the Work List (block 362).

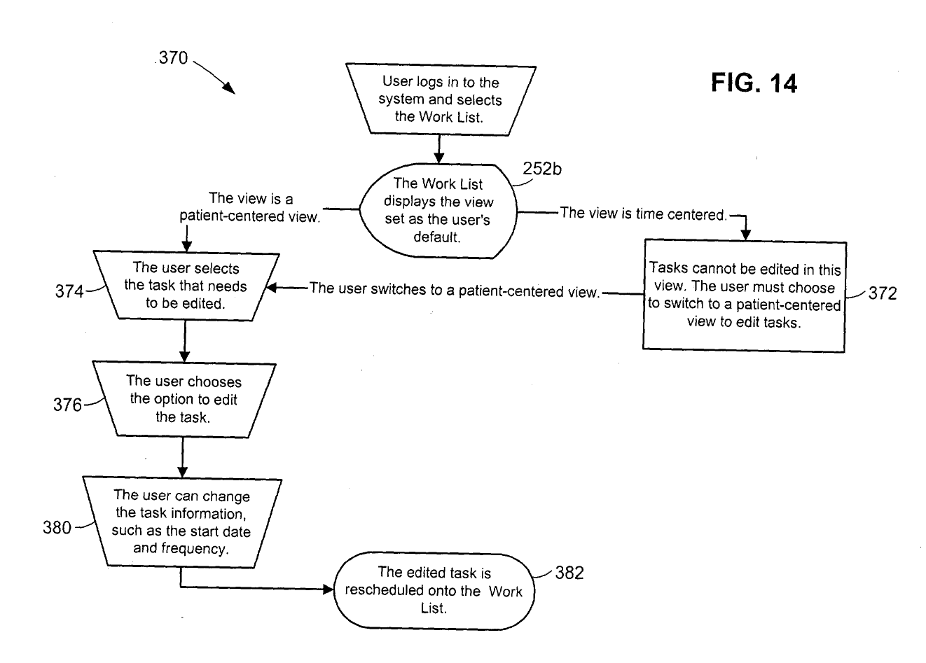

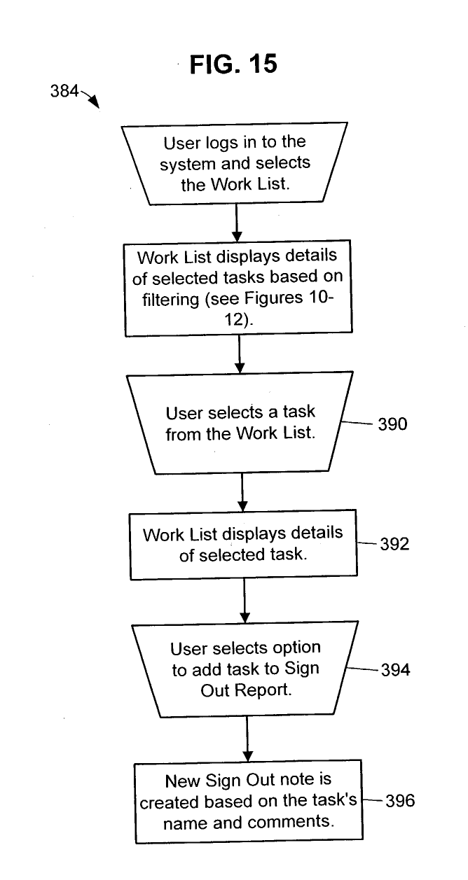

FIG. 14 is a flowchart, illustration 370 of some of the steps used to enable a user to edit tasks previously scheduled from a user interface. Tasks that have been scheduled through the activity assignment engine (see FIG. 5) as well as tasks that have been added directly from the user interface (see FIG. 13) can be edited. However, in order to be able to edit tasks, the system may check to ensure that the user has the proper security.

Once the user logs in to the system and selects the Work List option, the Work List is built from the selected Patient List (see FIG. 6). The Work List displays (block 252b) using the view that is set up in the user's default preferences (see FIG. 7). If the user's default view is time centered, the user may be prevented from editing the tasks (block 372). If the user wants to edit tasks, he or she could change the Work List view to a patient-centered view.

In a patient-centered view, the user can select the task that needs to be edited (block 374), and then can choose the option to edit the task (block 376). A window may appear that allows the user to change the task's information, such as its scheduling (start date and time, frequency, end date) as well as details on which caregivers can perform the task, identifying disciplines, licensures, and skill sets required to complete the duty (block 380). Comments can be added for the task, as well as changes to how the task can be marked completed, the category in which the task should be displayed, its priority, and the number of work units the task will take to accomplish. In this window, the user can also designate that the task should appear on the Sign Out Report (see FIG. 15).

Once the user has entered the information needed to edit the task, he or she can accept the task, and the task is rescheduled on the Work List (block 382). Therefore, if a task is edited so that it must be accomplished by a different discipline, it may no longer appear on the Work List for the user that edited the task. Similarly, if the scheduling information is edited, the task may appear at different times or frequencies on the Work List than it did before.

FIG. 15 is a flowchart 384 illustrating some of the steps used to convert a task into a Sign Out Note. In this context, the term “Sign Out Note” shall refer to one of a set of notes written by physicians, nurses and healthcare providers of various other disciplines, used to document general observations on a patient's condition. Sign Out Notes are related to patient care, but typically include observations and instruction that are not suitable for inclusion in the patient's permanent legal medical record.

Once the user has selected a Work List, available tasks may be displayed based on the filtering applied (see FIGS. 10-12). The user can then select a task from the list of tasks to see its details (blocks 390 and 392). Next, the user may select the option to add the task to a Sign Out Report (block 394). A new Sign Out Note may be created based on the task's name and comments for that patient, which can be viewed by creating a Sign Out Report for that particular patient (block 396). The new Sign Out Note could also include the time and date that the task was converted to a Shift Note, and the name of the user that converted it.

As a Sign Out Note, this note may not be added to the patient's permanent record, but it can be converted to a Progress Note, which will remain in the patient record. Converting a task to a Sign Out Note does not remove the task from the Work List.

FIG. 16 illustrates an exemplary flowchart 400 for some of the steps used to implement a task escalation policy for tasks on the Work List that have not been completed in a certain amount of time. Information about escalation may be included in the scheduled tasks based on the information from the Task Record. This amount of time can vary for each task, and is set in each task. When a task is scheduled onto the Work List, the system may determine whether an escalation policy has been specified at the task level (block 402). If an escalation policy is not specified, no task escalation will take place if the task is not completed within the stipulated time frame (block 404). If a policy is in effect, however, the system may wait to see if the task is completed before the time specified for escalation elapses (block 406). If the task is completed within the specified amount of time, no escalation policy is needed (block 410). If the task has not been completed within the specified time frame, the system may look to the task for an escalation policy (block 412). If there is not an escalation policy in the task, the unit's escalation policy may be followed (block 414). If the task contains an escalation policy, that policy is followed (block 416).

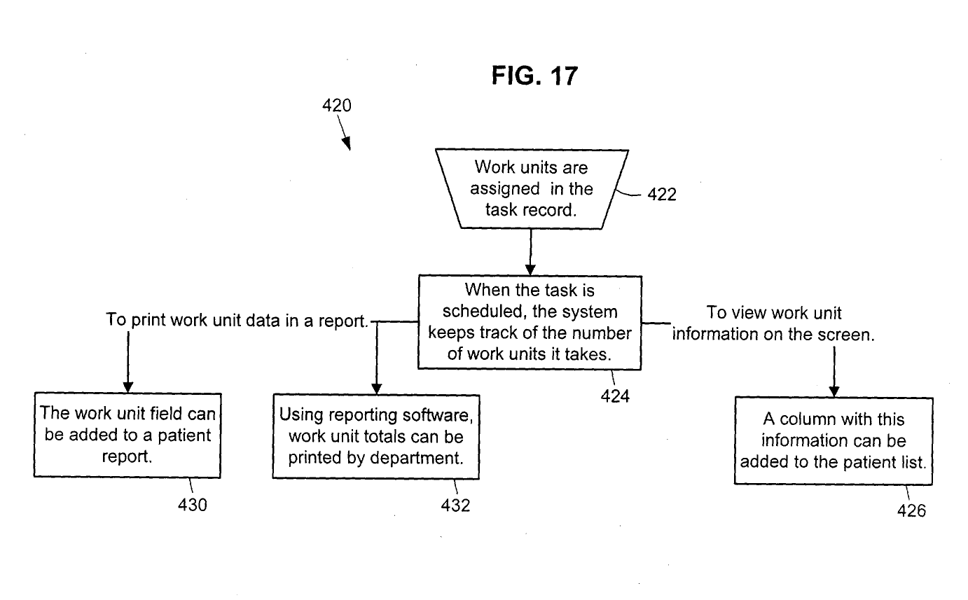

FIG. 17 illustrates the use of work units in a Work List in a flowchart 420. Work units are used as a measurement to specify how much time a task takes. The work units may be specified for each task in the Task Records (block 422). When the task is scheduled, the system may keep track of the number of work units the task takes (block 424). Work units can be viewed either on the computer screen or in a printout. To view the work unit information on the screen, the user can set up a column with this information in a Patient List (block 426). To view the work unit data in a printed report, the work unit field can be added to a patient report and then printed (block 430). To view more comprehensive data, this information can be placed in a departmental report using software that extracts data for reporting, and can then be printed (block 432). This report can help to determine staffing needs in a department by showing the total number of work units the department handles over a specified time period. In addition, it can help to measure staff productivity through analysis of the number of work units accomplished per person.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

What is claimed is:

1. A method of determining and displaying a plurality of tasks to a user in a healthcare environment comprising:
receiving an order associated with a patient;
determining a type of the order;
identifying a task template associated with the order;
determining if an overriding template exists for the order;
linking one of the task template or the overriding template to the order;
associating one or more task records with the linked template;
determining a plurality of tasks corresponding to the one or more task records;
adding the plurality of tasks to a work list;
assigning a number of work units for each of the plurality of tasks on the work list, the work units being indicative a length of time required to perform each the plurality of tasks;
filtering the plurality of tasks on the work list for a patient list based on an attribute of the user;
displaying the filtered list to the user;
identifying and implementing a task escalation policy if the task is not completed before an escalation time elapses; and
converting one of the plurality the tasks on the work list into a patient note if required.
